(19) United States
(12) Patent Application Publication
(10) Pub. No.: US 2005/0194243 A1
(43) Pub. Date: Sep. 8, 2005

(54) Remotely controlled rocker switches

(76) Inventor: Frank Joseph Prineppi, Fort Lauderdale, FL (US)

Correspondence Address: BAKER & DANIELS LLP, 300 NORTH MERIDIAN STREET, SUITE 2700, INDIANAPOLIS, IN, 46204, US

(21) Appl. No.: 11/070,144

(22) Filed: Mar. 2, 2005

(30) Foreign Application Priority Data
Mar. 3, 2004 (GB) GB0404766.8
Apr. 29, 2004 (GB) GB 0409557.6

(51) Int. Cl. H01H 3/20

(52) U.S. Cl. 200/556

(57) ABSTRACT

A remote control adaptor assembly for remotely moving a rocker switch between an on position and an off position. The remote control includes a housing mounted at a location remote from the switch, a radio frequency receiver unit disposed within the housing, a motor operably coupled to the receiver unit, an actuator operably coupled to the motor and extending from the housing, and a remote control transmitter in communication with the receiver unit. The receiver unit receives signals form the transmitter and in response to the signals the motor moves the actuator between a first engaging position, a second engaging position, and a rest position. The actuator moves the switch between the on position and the off position when the actuator moves between the first engaging position and the second engaging position respectively. The actuator permits the switch to be manually operated when the actuator is in the rest position.

### BACKGROUND OF THE INVENTION

1. Field of the Invention

This invention relates to rocker switches of the type which are typically wall mounted and are used to turn e.g. electric lights on and off.

2. Description of the Related Art

As is apparent, a feature of manually operable rocker switches is that where they are wall mounted in e.g. a bedroom, additional lighting is required next to a bed if an occupant of the bedroom wishes to avoid the inconvenience of locating the rocker switch in the dark or locating the bed once the switch has been turned off at night, in each case causing potential injury and/or accidental damage to objects within the room. On the other hand, having a light next to a bed represents an additional expense in terms of cost and space, as well as requiring the use of an additional mains socket and associated wiring. A bedside light may also not be considered “cool” by e.g. the younger generation to the extent that inconvenience, injury or accidental damage may be considered an acceptable risk as an alternative to being seen to have bedside lighting.

These problems are addressed in part by a remote control light switch actuator sold under the trade mark Lights Off by Wild Planet Toys, Inc. in which a remote control transmitter is used to operate a light rocker switch actuator contained within a housing which fits over the entire light switch and associated switch cover plate, being releasably secured thereto by means of Velcro® strips on the underside of the housing and glued also to the switch plate to thereafter, if aligned properly, allow the rocker switch to be operated via the remote control instead of by hand. A separate manual switch on the side of the housing permits the rocker actuator to be activated independently of the remote control unit. Whilst this is an improvement over a solely manually operated rocker switch it will be understood that correct operation depends upon accurate alignment of the housing over the light switch and whenever the batteries within the housing need to be changed the housing has to be removed and thereafter realigned accordingly.

The present invention is derived from the realisation that it would be preferable to provide a manual override for the rocker switch itself whilst still allowing for remote activation of the rocker switch when desired.

### SUMMARY OF THE INVENTION

According to the invention there is provided a remote control adaptor for remotely operating a rocker switch, the adaptor includes a housing for a battery operated radio frequency (RF) receiver unit, electric motor and associated gearing for driving a switch rocker actuator. The housing is adapted to be mounted remote from the switch. The switch rocker actuator extends from the housing and is adapted to engage with the switch to thereby selectively move it from an on position to an off position and vice versa in response to a command signal from a remote control transmitter to the RF unit. The adaptor allows the switch to be manually operated when the actuator is at rest.

In this patent specification the term “rocker switch” is intended to mean switches which may be operated by being pressed on one side or other of a pivot point and also switches which operate by being flicked from one orientation to another about a pivot point, often called toggle switches.

In one embodiment, the switch rocker actuator takes the form of a rotatable rod having a pair of oppositely disposed cam lobes projecting therefrom. The rod itself is positionable just above the rocker switch if of the press down type so that when the cam lobes adopt a common plane parallel to the major plane of the switch cover plate they do not touch the switch so that it may still be activated manually. When the rod is rotated through 90° one or other of the cam lobes pushes against a respectively raised part of the switch rocker to thereby operate the switch, and by continuing to rotate through a further 90° the actuating rod comes back to rest in a position where the other of the cam lobes is ready to perform the next cycle while still permitting the switch to be manually operated.

In another embodiment, the switch rocker actuator takes the form of pull rods each connected at a rocker switch operating end to a rocker switch actuator arm and having moveably mounted cam followers at the opposite end spring biased to pull the rods and associated actuator arms to respective positions away from the rocker switch, thereby permitting the rocker switch to be operated manually. The cam followers are selectively operable by respective cams rotatably connected to the electric motor and associated gearing whereby the switch rocker actuator arms are able to actuate respective parts of the switch via arcuate movement but not rotational movement, thereby enabling the remote control adapter to be more compact than through the use of a switch rocker actuator that requires rotational movement through 360°.

In one aspect, the invention also provides means to sense the condition of the rocker switch to ensure that a required condition, either ‘on’ or ‘off’ can be positively assured. This feature is particularly useful where the rocker switch cannot be visually inspected or where it is wired into an electrical circuit such that, depending on the last command received from, say, one of multiple transmitters, the switch state remains unknown and unpredictable.

In another aspect, the housing includes a fastener extending therethrough and having a knob on one end, by which it may be rotated, and a screw thread on the other end, by which the housing may be secured to the rocker switch housing in substitution for one of the screws conventionally holding the cover plate onto the switch housing. In yet another concept, the housing itself is shaped to engage surfaces of the cover plate to ensure accurate alignment of the housing and hence switch rocker actuator relative to the rocker switch.

In another embodiment, the housing includes a switch by which the switch rocker actuator is allowed to rotate only through 180° at a time by the use of a limit switch, representing sequential switching on and off of the rocker switch.

In a further embodiment of the invention, particularly where a “toggle” type of rocker switch is involved, a toggle switch adaptor piece is provided. The toggle switch adaptor piece is adapted to attach to the toggle switch and includes a collar from which extend a pair of oppositely disposed side flaps. The side flaps may be sequentially pressed to activate the rocker switch while still permitting the switch to be operated manually when the switch rocker actuator when in its disengaged condition.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a perspective view of a wall mounted rocker switch and associated cover plate assembly, over part of which has been mounted a remote control adaptor in accordance with the invention,

FIG. 2 is a perspective view of a remote control transmitter unit for operating the remote control adaptor of FIG. 1,

FIG. 3 is an end view of the arrangement of FIG. 1 showing how the remote control adaptor is able to operate the rocker switch,

FIG. 4 is an exposed view of a housing and associated switch rocker actuator of the remote control adaptor of the invention,

FIG. 5 is a perspective view of the switch rocker actuator of FIG. 4 minus its respective gear drive wheel and showing the limit switch actuator,

FIG. 6 is a perspective view of an adaptor piece for fixing onto a toggle type of rocker switch,

FIG. 7 is a perspective view of a remote control adaptor piece onto the cover plate of a toggle type rocker switch to which the adaptor piece of FIG. 6 has been attached,

FIG. 8 is a side view to that shown of FIG. 7 showing the mode of operation

FIG. 9 is a perspective view of the actuator rod forming part of the remote control adaptor shown in FIG. 1 but including means for sensing the condition of a rocker switch,

FIG. 10 is a plan, part sectioned, view of an embodiment of remote control adaptor with the top part of its housing exposed for clarity,

FIG. 11 is a partially exposed side view of the embodiment of FIG. 10,

FIG. 12 is a perspective schematic view of part of the operation of the preferred embodiment of the FIG. 10, and

FIG. 13 is a schematic side view showing the operation of part of the actuator assembly shown in FIG. 12.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE DRAWINGS

The embodiments hereinafter disclosed are not intended to be exhaustive or limit the invention to the precise forms disclosed in the following description. Rather the embodiments are chosen and described so that others skilled in the art may utilize its teachings.

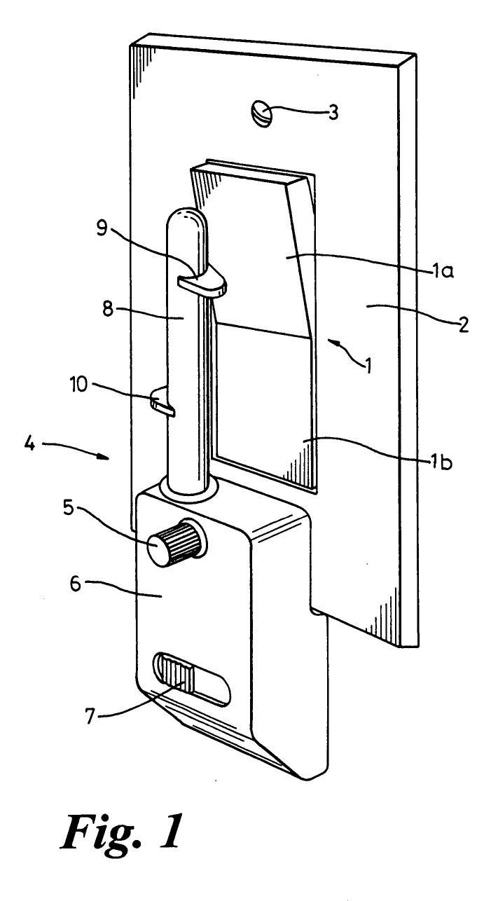

Referring firstly to FIG. 1 there is shown a rocker switch 1 of the push down type and associated cover plate 2, the switch 1 having inclined halves 1a, 1b such that when one half is pressed down it rests flush with the cover plate 2, in this case half 1b, while the other, in this case half 1a, rests above the surface of the cover plate 2 in an inclined position such that it may be pressed downwards to activate or deactivate the switch.

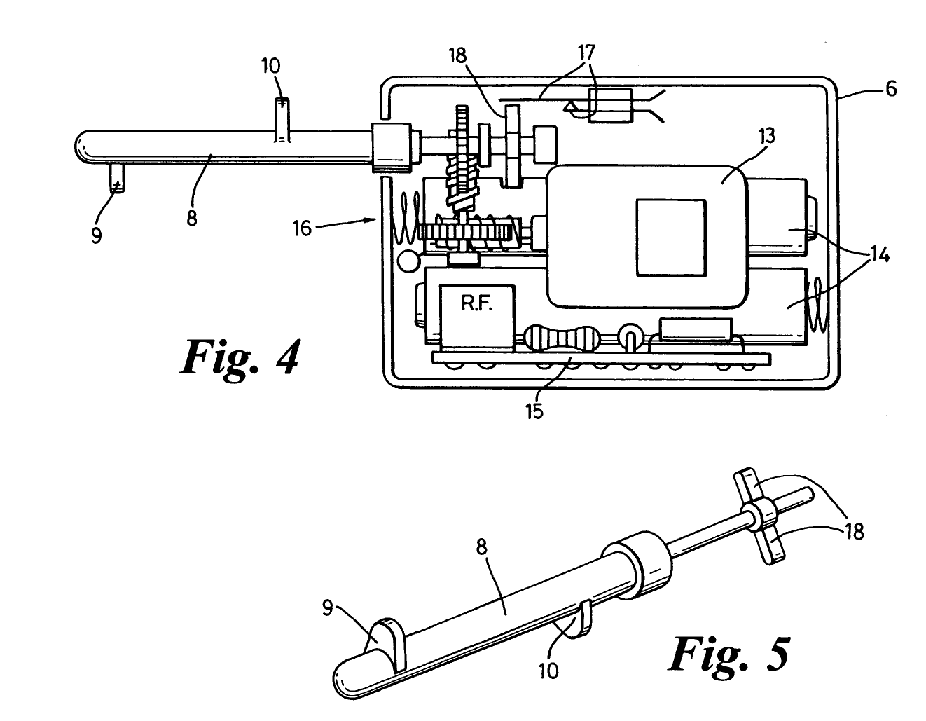

A retaining screw 3 secures the cover plate 2 in place over a switch housing (not shown) embedded in the wall and would ordinarily be one of two such screws 3 disposed at respectively opposite ends of the cover plate 2. However, in accordance with this embodiment of the invention, a remote control adaptor unit shown generally at 4 is releasably secured to the cover plate 2 by virtue of the threaded end (not shown) of a mounting screw or bolt having at its other end a knob 5 by which the threaded end can be rotated and hence secured within the threaded recess normally occupied by the other of the screws 3, to thereby releasably secure the remote control adaptor 4 against the cover plate 2. The adaptor 4 comprises a housing 6 containing components to be described with reference to FIGS. 4 and 5, and an override switch 7 for manually operating a rotatable switch rocker actuator rod 8 extending from the housing 6 parallel to the cover plate 2 over the switch 1, the actuator rod 8 also including oppositely disposed cam lobes 9, 10 for bearing against, in use, respective halves 1a, 1b of the switch 1 in a manner to be described.

The housing 6 is shaped to engage an edge of the cover plate 2 so as to prevent or inhibit twisting of the adaptor 4 relative to the switch 1.

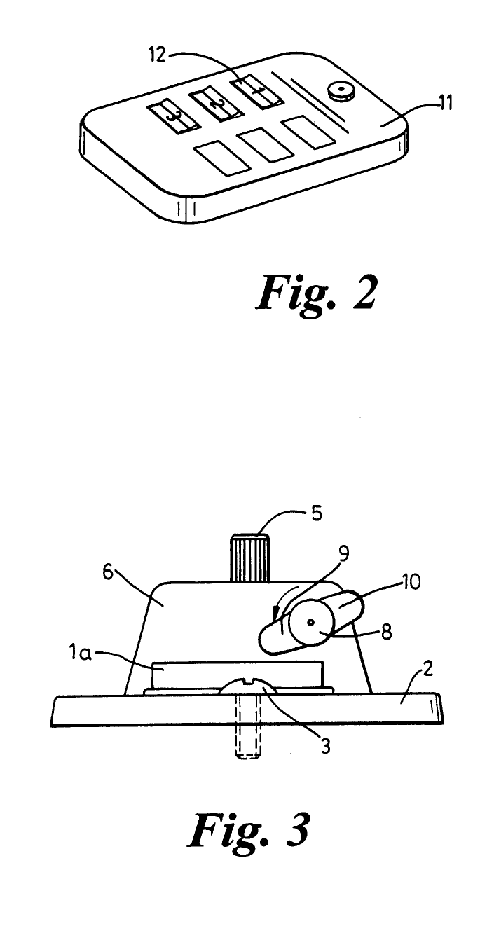

In FIG. 2 there is shown a remote control transmitter 11 with an associated control panel 12 by which e.g. several rocker switches may be selectively activated or deactivated.

In FIG. 3 there is shown a partly schematic end view of the arrangement of FIG. 1 in which it will be seen that the switch rocker actuator 8 is partly rotated from a rest position to first and second switch engaging positions. In the rest position, the cam lobes 9, 10 lie on a common plane parallel to but spaced from the major plane of the switch cover 2, thus cam lobes 9, 10 do not engage switch 1. In the first and second engaging positions cam lobes 9, 10 lie in a common plane perpendicular to the major plane of switch cover 2. More particularly, in the first engaging position, cam lobe 9 engages inclined half 1a of switch 1 to move switch 1 into the on position. In the second engaging position, cam lobe 10 engages inclined half 1b of switch 1 to move switch 1 into the off position. The position shown indicates that a command signal has just been received from the remote control transmitter 11 for the actuator rod 8 to be rotated through 180°. As will be apparent, as the cam lobe 9 presses the rocker switch half 1a downwards it activates or deactivates the switch 1, as the case may be, and continues turning along with cam lobe 10 on the actuator rod 8 until the cam lobe 10 is in position above the, now raised, switch half 1b such that upon a further command signal being received from the remote control transmitter 11 switch half 1b would then be pressed down in sequence.

Turning now to FIGS. 4 and 5 there are shown respective views of the housing 6 opened and a perspective detail of the switch rocker actuator 8. In the housing 6 is an electric motor 13 powered by batteries 14, which also power a radio frequency receiver and control logic unit (RF) 15 for receiving signals from the remote control unit 11 for operating the motor 13. Between the motor 13 and the switch rocker actuator 8 is a drive train shown generally at 16 comprising sun and worm gears by which the initial speed of rotation of the motor 13 is reduced to a required level. In order to arrest rotation of the motor 13 and hence rocker switch actuator 8 every 180° a limit switch 17 is provided and biased to the closed position but may be opened by a switch activator in the form of a pair of oppositely disposed switch deactivator arms 18 mounted for rotation with the switch rocker actuator 8, the arms being disposed radially offset by 45° to the common plane of the cam lobes 9, 10 to ensure that the lobes always come to rest on a plane parallel to but spaced from the major plane of the switch cover plate 2 to thereby always permit the switch 1 to be operated manually.

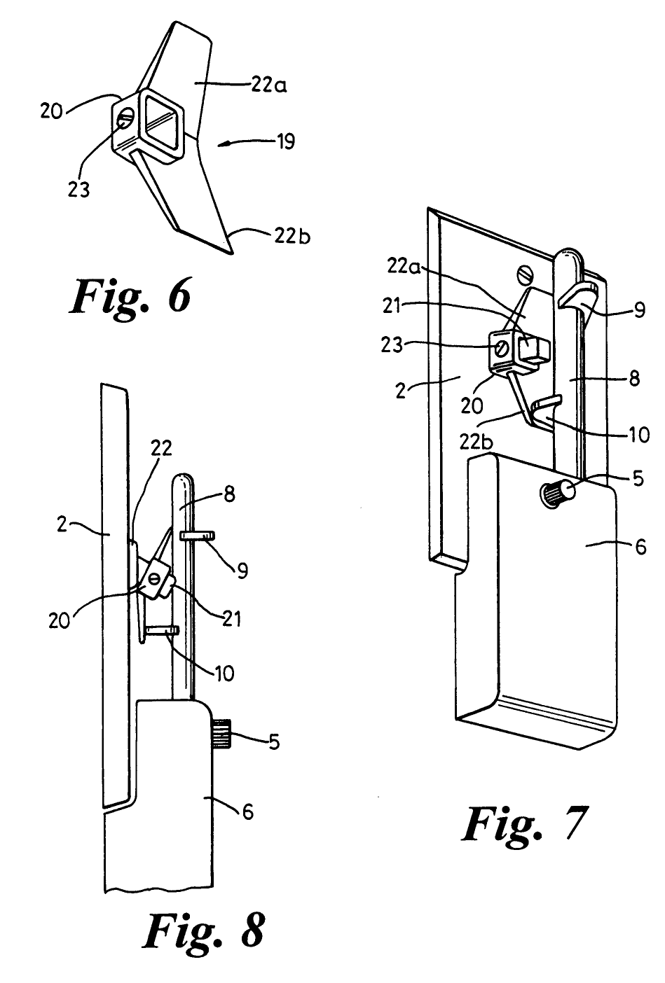

Turning now to FIGS. 6 to 8, there is shown an arrangement in which the remote control adaptor 1 shown in FIGS. 1 to 5 may be used to activate a toggle type of rocker switch through the use of an adaptor piece shown generally at 19. This comprises a collar 20 adapted to fit over the stem 21 of the toggle switch 22 (seen more clearly in FIG. 8), and having a centrally disposed screw 23 by which it may be releasably secured thereto.

A pair of switch actuating flaps 22a, 22b extends outwardly from the collar 20 and are inclined with respect to each other in a manner analogous to the switch halves 1a, 1b of the switch 1 such that when the adaptor piece 19 is attached to the stem 21 of the switch 22 the switch 22 may be operated by pressing either of the flaps 22a, 22b. As can be seen from FIG. 8, this allows the cam lobes 9, 10 of the actuator rod 8 to be used to operate the switch 22 when the switch rocker actuator 8 is rotated in response to a command signal from the remote control unit 11.

Although the invention thus far described provides a remote control adaptor for remotely operating a rocker switch by the use of a switch rocker actuator having cam lobes which are sequentially rotated to operate the switch, it will be understood that other configurations may be adopted, such as configurations in which translational movement instead of rotational movement is used to activate or deactivate the switch, as the case may be, while still allowing the switch to be manually operated as required, without departing from the spirit or scope of the invention.

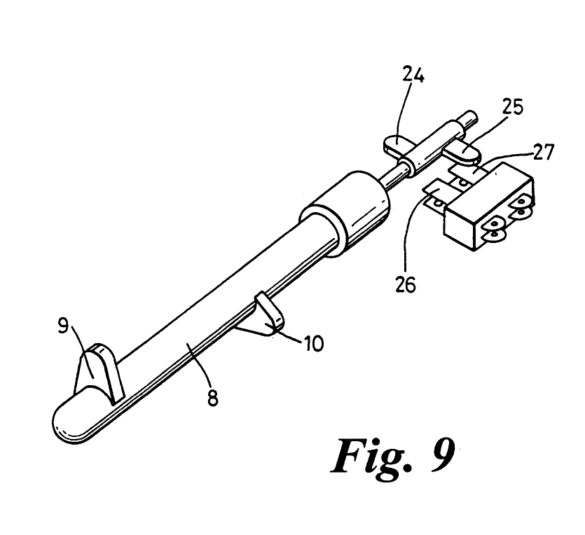

Turning now to FIG. 9 there is shown a perspective view of the actuator rod 8 and associated cam lobes 9, 10 which includes at a distal end thereof a pair of secondary switch operating lobes 24, 25 fixed for rotation with the actuator rod 8 and being in an oppositely disposed stepped configuration such that upon rotation of the actuator rod 8 each lobe 24, 25 sequentially closes a respective pair of electrical contacts 26, 27 forming part of the circuit to the radio frequency receiver and control logic unit 15 (not shown) for providing a means to sense the condition of the rocker switch 1 (not shown) i.e. whether it is ‘on’ or ‘off’. With this arrangement, if the start condition of the rocker switch 1 is unknown and it is to be turned e.g. ‘on’ the control logic unit 15 initiates operation of the motor 13 and as the two lobes 24, 25 pass their respective contact pairs 26, 27 they signal their position to the control logic unit 15. If the ‘off’ contact pair 26 is open it confirms that the rocker switch 1 has now passed into the off position. If that is the condition the initial command requires, then the motor 13 is stopped. Otherwise, rotation of the switch actuator 8 continues until the other lobe 25 passes over the contact pair 27 signalling the new wall switch condition.

As will be appreciated, since the rocker switch 1 can be manually overridden so that there is no way of determining the switch state at any particular time, the motor 13 must always go through at least one cycle to ensure that it leaves the rocker switch 1 in the desired state. In other words, if the switch 1 has been manually set to the ‘on’ position and the remote control transmitter 11 (not shown) gives the command to turn the switch on the switch actuator 8 must cycle through ‘off’ and then ‘on’ so as to be certain that it ends up in the correct position. On the other hand, if the rocker switch 1 is in the off position and a command signal is given to turn it on, the actuator 8 will cycle only once to the on position and then stop. As will also be appreciated, this requires a slightly more complex command string from the control logic unit 15 and associated remote control unit 11 requiring a unique controller address code which selects the desired wall-switch controller, followed by the on or off command code as necessary

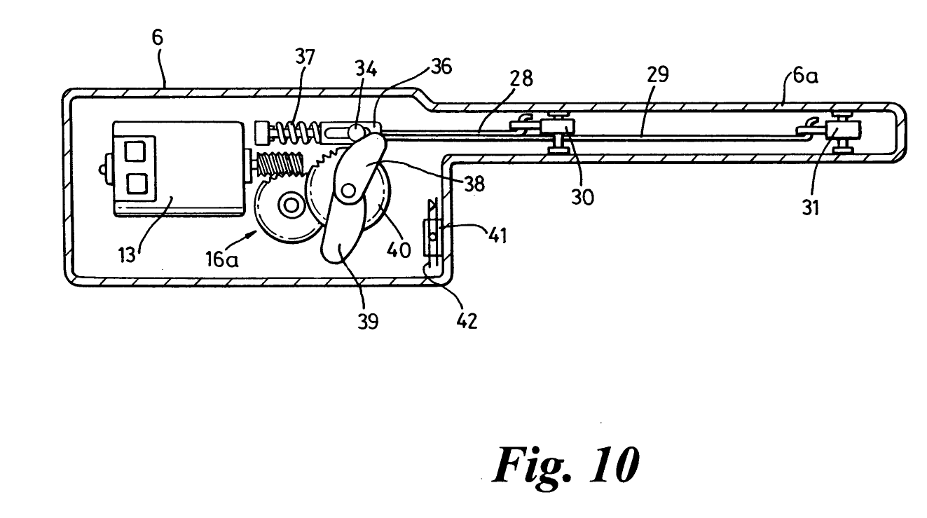

Turning now to FIGS. 10 to 13 there are shown respective views of a preferred embodiment of remote control adapter in which the rocker switch actuator mechanism uses a pair of pull rods 28, 29 which operate respective crank arms 30, 31 housed primarily within an extension arm 6a of the housing 6 each crank arm 30, 31 being secured for arcuate movement about respective pivots 32, 33.

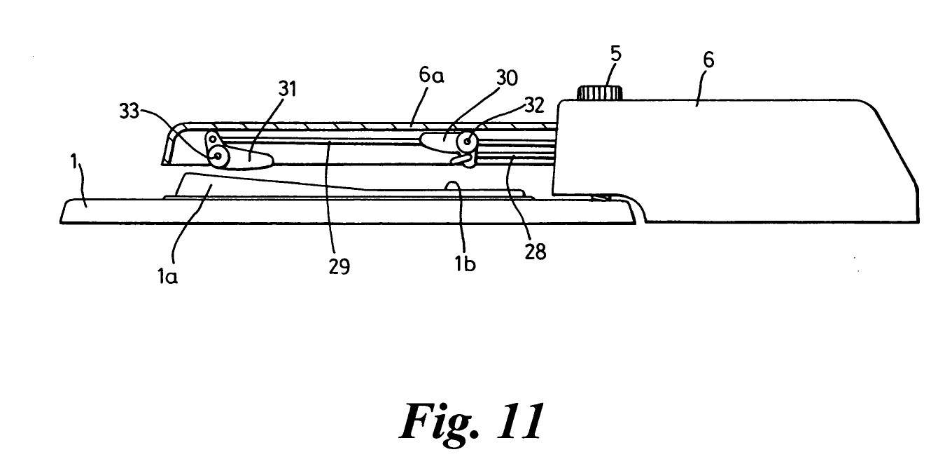

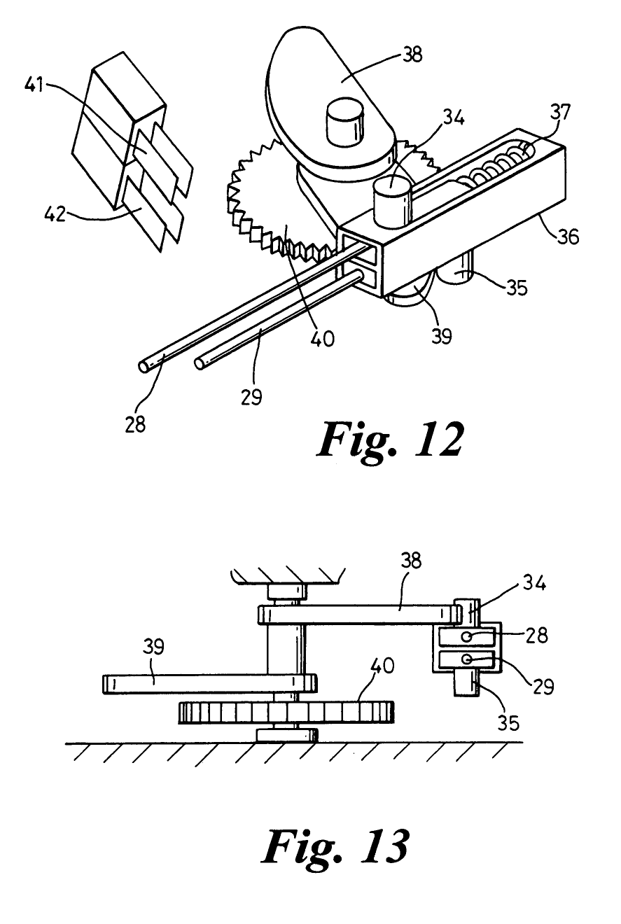

As can be seen more clearly with reference to FIGS. 10 and 12, the end of the pull rods 28, 29 remote from the crank arms 30, 31 are connected to respective pairs of slidable cam followers 34, 35 received within a cam follower housing 36, each cam follower 34, 35 being biased by respective springs 37 to push each respective pull rod 28, 29 away from the housing 6 to thereby maintain the crank arms 30, 31 in their rest position shown in FIG. 11 following actuation of the switch 1 to either the on or off positions.

The cam followers 34, 35 are actuated during a cycle for switching on or off the rocker switch 1 by respective cam lobes 38, 39 mounted for rotation with a spur gear 40 forming part of a speed reduction drive train shown generally at 16a driven by the motor 13 (shown in FIG. 10).

As with the switch actuator rod 8 described with reference to FIG. 9 a pair of cam lobe operated contact switches 41, 42 are provided for respective cam lobes 38, 39 to sense the condition of the rocker switch 1 in the manner as described with reference to FIG. 9.

In operation of this cam biased embodiment, and as shown initially with reference to FIG. 11, the housing 6 is shown mounted via the threaded end of knob 5 on an edge portion of the rocker switch 1 such that the housing extension arm 6a extends over switch halves 1a, 1b, where crank arm 31 is spaced from but within range of switch half 1a when the latter is in its raised position shown and crank arm 30 is spaced from and within range of switch half 1b when the latter is in its raised position. As will be seen more clearly in FIG. 10, when the spur gear 40 is caused to rotate anti- or counter-clockwise the upper cam lobe 38 is able to temporarily engage with the cam follower 34 to drive it and the pull rod 28 and associated crank arm 30 against the bias of the spring 37. As this happens the other cam lobe 39, being diametrically opposite cam lobe 38 with respective to the spur gear 40, engages with its respective contact switch pair 42 to enable the control logic unit 15 (not shown) to determine the condition of the rocker switch 1, or at least partially determine that condition, in the manner as explained with reference to FIG. 9.

Upon further rotation of the cam lobe 30 it reaches a point whereby cam follower 34 is then free to be pushed back by the bias of the spring to its normal rest position as shown in FIG. 11. In the interim in the event that the switch half 1b was initially in its raised position, it will have been pressed down by the end of the crank arm 30 leading to the condition shown in FIG. 11, in which condition the crank arm 31 pivotally attached to the pull rod 29 is in a position by which it may be moved downwards to press against the switch half 1a upon the cam lobe 39 bearing against its respective cam follower 35 when the spur gear 30 has rotated by a further half turn.

At the end of each cycle one or other of the cam lobes 38, 39 engages its respective contact switch pair 41, 42 which enables the control logic circuit 15 to determine the location of the cam lobes 38 and 39. By knowing this location, the logic controller circuit unit 15 can determine which cam lobe will engage which of the cam followers 34, 35 and subsequently activate pull rods 28 or 29, during the next motor operation. The controller unit 15 thereby applies either one or two cycles to the operation, ensuring the rocker switch 1 is left in the required state.

As will be appreciated, the difference between the configuration shown in the embodiment of remote control rocker switch actuator shown with reference to FIGS. I to 9 as compared to the cam biased embodiment shown with reference to FIGS. 10 to 13 is that in the former the cam lobes 9, 10 have to rotate through a full 360° in order for one cycle to be completed, meaning that if it is contained within e.g. a protective housing, the housing has to be of a size sufficient to accommodate this rotational movement. On the other hand, since the crank arms 30, 31 of the cam biased embodiment only have to rotate through 90° it will be understood that the housing arm 6a can be effectively half as thick as would otherwise be the case and hence can be made much more compact and aesthetically pleasing. In addition, because the crank arms 30, 31 swivel through 90° about an axis transverse to the major axis of the housing arm 6a the latter can be made relatively slim, requiring only sufficient room for the presence of the pull rods 28, 29 and their respective crank arms 30, 31 and pivots 32, 33.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A remote control adaptor assembly for remotely operating a rocker switch, the rocker switch extending from a rocker switch cover and movable between an on position and an off position, the remote control adaptor comprising:
a housing adapted to be mounted at a location remote from the switch;
a radio frequency receiver unit disposed within said housing, said receiver unit communicable with a radio frequency transmitter remote from said housing, said receiver unit capable of receiving signals from the transmitter when in communication therewith;
a motor disposed within said housing and operably coupled to said receiver unit; and
a switch rocker actuator operably coupled to said motor and extending from said housing;
wherein in response to said signals said motor is configured to move said actuator between a first engaging position, a second engaging position, and a rest position; and wherein said actuator is adapted to engage with the switch to move the switch between the on position and the off position when said actuator moves between the first engaging position and the second engaging position respectively; and wherein said actuator is adapted to permit the switch to be manually operated when said actuator is in said rest position.

2. An adaptor assembly according to claim 1 wherein said actuator comprises a rotatable rod having a pair of oppositely disposed cam lobes projecting from said rod.

3. An adaptor assembly according to claim 1 wherein the switch rocker actuator comprises a pair of pull rods, each of said pull rods having a first end pivotably connected to an actuator arm and a second end moveably mounted to a cam follower, said cam follower being operably connected to said motor such that said motor causes arcuate movement of said cam follower, said arcuate movement of said cam follower affects both the movement of said pull rods and the pivoting of said actuator arm between said first and second engaging positions, said cam follower including a spring biased to pull said rods and said actuator arm to said rest position.

4. An adaptor assembly according to claim 1 further comprising a controller unit coupled to said receiver unit, said controller unit having a sensor sensing the position of said actuator to ensure that the rocker switch is in either the on or the off position.

5. An adaptor assembly according to claim 1 further including a fastener extending through said housing, said fastener including a knob on one end by which it may be rotated and a screw thread on the opposite end, said screw thread engaging the cover to secure said housing to the cover.

6. An adaptor assembly according to claim 1 wherein said housing is shaped to engage an edge of the cover to prevent movement of said housing relative to the cover.

7. An adaptor assembly according to claim 2 further including a limit switch, said limit switch restricting the rotation of said rod.

8. An adaptor assembly according to claim 1 further comprising a toggle switch adaptor piece engagable to the rocker switch, said adaptor piece having a collar and a pair of side flaps extending from opposite sides of said collar, and said actuator adapted to engage the switch through said side flaps.

9. A remote control adaptor assembly for remotely moving a rocker switch between an on and an off position in response to a signal from a transmitter remote from the rocker switch, the rocker switch extending from a cover, the adaptor comprising:
a housing mountable on the cover;
a receiver unit disposed within said housing, said receiver unit adapted to receive the signal from the remote control transmitter,
a motor disposed within said housing and operably coupled to said receiver unit; and
an actuator operably coupled to said motor, said actuator including a rotatable rod extending from said housing and a pair of diametrically disposed cam lobes projecting from said rod, said motor driving the rotation of said rod between a first engaging position, a second engaging position, and a rest position,
wherein a first of said lobes is adapted to engage with the switch to move the switch to the on position when said actuator rotates to said first engaging position, a second of said lobes is adapted to engage with the switch to move the switch to the off position when said actuator rotates to said second engaging position, and wherein both of said lobes are adapted to disengage the switch when said actuator is rotated to said rest position.

10. An adaptor assembly according to claim 9 further comprising a controller unit coupled to said receiver unit, said controller unit having a sensor sensing the position of said lobes to ensure that the rocker switch is in either the on or the off position.

11. An adaptor assembly according to claim 9 further including a fastener extending through said housing, said fastener engaging said housing to the cover to secure the adaptor assembly to the switch.

12. An adaptor assembly according to claim 9 wherein said housing is shaped to engage an edge of the cover to prevent movement of said housing relative to the cover.

13. An adaptor assembly according to claim 9 further including a limit switch, said limit switch restricting the rotation of said rod.

14. An adaptor assembly according to claim 9 further comprising a toggle switch adaptor piece engagable to the rocker switch, said adaptor piece having a collar and a pair of side flaps extending from opposite sides of said collar, and said cam lobes adapted to engage the switch through said side flaps.

15. A remote control adaptor assembly for remotely moving a rocker switch between an on and an off position in response to a signal from a transmitter remote from the rocker switch, the rocker switch extending from a cover, the adaptor comprising:
a housing mountable on the cover;
a receiver unit disposed within said housing, said receiver unit adapted to receive the signal from the remote control transmitter;
a motor disposed within said housing and operably coupled to said receiver unit; and
an actuator operably coupled to said motor, said actuator including a pair of pull rods, each of said pull rods having a first end pivotably connected to an actuator arm and a second end moveably mounted to a cam follower, said cam follower being operably connected to said motor such that said motor causes arcuate movement of said cam follower, said arcuate movement of said cam follower affects the translation of said pull rods between a first engaging position and a second engaging position, said cam follower having a spring biased to pull said rods and said actuator arm to a rest position,
wherein said actuator arm of one of said pair of pull rods is adapted to engage with the switch to move the switch to the on position when said pull rods translate to said first engaging position, said actuator arm of the other of said pair of pull rods is adapted to engage with the switch to move the switch to the off position when said pull rods translate to said second engaging position, and wherein said actuator arm of each of said pair of pull rods are adapted to disengage the switch when said pull rods translate to said rest position.

16. An adaptor assembly according to claim 15 further comprising a controller unit coupled to said receiver unit, said controller unit having a sensor sensing the position of said actuator to ensure that the rocker switch is in either the on or the off position.

17. An adaptor assembly according to claim 15 further including a fastener extending through said housing, said fastener engaging said housing to the cover to secure the adaptor assembly to the switch.

18. An adaptor assembly according to claim 15 wherein said housing is shaped to engage an edge of the cover to prevent movement of said housing relative to the cover.

19. An adaptor assembly according to claim 15 further comprising a toggle switch adaptor piece engagable to the rocker switch, said adaptor piece having a collar and a pair of side flaps extending from opposite sides of said collar, and said actuator arms adapted to engage the switch through said side flaps.

20. An adaptor assembly according to claim 15 wherein said motor and said receiver are battery powered.
